(19) United States
(12) Patent Application Publication
(10) Pub. No.: US 2025/0328571 A1
(43) Pub. Date: Oct. 23, 2025

(54) SYSTEMS AND METHODS FOR GENERATING CONTEXT SUMMARIES FOR DATA TRANSFERS

(71) Applicant: The Toronto-Dominion Bank, Toronto (CA)

(72) Inventors: Hitesh BAJAJ, Duluth, GA (US); Milos DUNJIC, Oakville (CA); David Samuel TAX, Toronto (CA); Jonathan Joseph PRENDERGAST, West Chester, PA (US); Mohit SHARMA, Toronto (CA); Abhijit SINGHA HAZARI, Oakville (CA); Pranay GUPTA, Toronto (CA); Kushank RASTOGI, Toronto (CA); Thomas KELLY, Wenonah, NJ (US)

(73) Assignee: The Toronto-Dominion Bank, Toronto, ON (CA)

(21) Appl. No.: 18/640,212

(22) Filed: Apr. 19, 2024

(51) Int. Cl. G06F 16/34; G06F 16/383

(52) U.S. Cl. CPC G06F 16/345; G06F 16/383

(57) ABSTRACT

The present disclosure relates to systems and methods for generating summaries about context of data transfers using trained machined learning models. There is provided a computer system, comprising a processor, a communications module coupled to the processor, and a memory coupled to the processor. The memory stores instructions that, when executed, configure the processor to receive an indication to view a record of a data transfer on a device, collect metadata associated with the data transfer and device data associated with the data transfer from the device, generate a context summary of the data transfer based on the metadata and the device data using a trained machine learning model, and transmit a signal to the device to display the context summary in association with the record of the data transfer.

### TECHNICAL FIELD

The present application relates to generating summaries about context of data transfers and, more particularly, to systems and methods for generating data transfer context summaries using trained machine learning models.

### BACKGROUND

Data transfers occur on a daily basis. While records are often made of those transfers, and presented in the form of receipts, invoices, or the like, the information provided is often high-level, non-intuitive, obscure, and minimal, or the record (such as a physical receipt) may be easily discarded or lost over time. Thus, when reviewing past data transfers, it can be difficult for the individual to remember what the purpose of the data transfer was, how the transfer occurred, and/or why the transfer was made. This can lead to inaccurate or inefficient record keeping, and can make fraudulent or erroneous transfers harder to detect.

Meanwhile, machine learning (ML) models, including generative artificial intelligence (GenAI), are capable generating text, images, and other media from generative artificial intelligence models such as large language models, multi-modal large language models, neural networks, and the like. A GenAI model can learn patterns and structure of the training data input to the GenAI model during training, and then use what is learned during the training to generate new data with similar characteristics.

### BRIEF DESCRIPTION OF THE DRAWINGS

Embodiments are described in detail below, with reference to the following drawings:

FIG. 1 is a schematic operations diagram illustrating an operating environment of a computer system according to an example embodiment of the present disclosure;

FIG. 2 is a simplified schematic diagram showing components of an example computer device;

FIG. 3 is a high-level schematic diagram of an example computer system;

FIG. 4 shows a simplified organization of software components stored in a memory of the computer system of FIG. 3;

FIG. 5 is a schematic diagram illustrating a generative artificial intelligence (GenAI) computing environment of the computer system of FIG. 1 according to example embodiments;

FIG. 6 is a diagram illustrating processes for training a machine learning model according to example embodiments; and

FIG. 7 is a flowchart showing operations performed by the computer system of FIG. 5 for generating summaries about the context of data transfers according to example embodiments.

Like reference numerals are used in the drawings to denote like elements and features.

### DETAILED DESCRIPTION

In one aspect of the present disclosure, there is provided a computer system, comprising: a processor; a communications module coupled to the processor; and a memory coupled to the processor, the memory storing instructions that, when executed, configure the processor to: receive an indication to view a record of a data transfer on a device; collect metadata associated with the data transfer and device data associated with the data transfer from the device; generate a context summary of the data transfer based on the metadata and the device data using a trained machine learning model; and transmit a signal to the device to display the context summary in association with the record of the data transfer.

In some implementations, the metadata comprises one or more of a date and a time of the data transfer.

In some implementations, the device data comprises one or more of location data, calendar data, image data, contact data, and email data of or on the device.

In some implementations, one or more of the location data, the image data, and the email data are identified to be associated with the data transfer when a date and timestamp associated respectively with the location data, the image data, and the email data are within a predetermined threshold relative to the date and the time of the data transfer.

In some implementations, the image data comprises an image, the trained machine learning model comprises an image processing neural network trained to analyze and describe the image, and the instructions, when executed, further configure the processor to collect the image data by generating a description of the image using the image processing neural network.

In some implementations, the instructions, when executed, further configure the processor to obtain supplementary data based on the metadata and the device data by processing the metadata and the device data.

In some implementations, the instructions, when executed, further configure the processor to obtain the supplementary data by querying third-party databases using the metadata and the device data.

In some implementations, the supplementary data comprises one or more of weather data and traffic data.

In some implementations, the instructions, when executed, further configure the processor to generate the context summary by determining key points relating to context of the data transfer from the metadata, the device data, and the supplementary data using the trained machine learning model.

In some implementations, the trained machine learning model is a text summarizer that uses natural language processing (NLP) techniques.

In some implementations, the context summary is a listing of the key points.

In some implementations, the trained machine learning model is a generative artificial intelligence (GenAI) model, and wherein the instructions, when executed, further configure the processor to: generate a prompt to the GenAI model for generating the context summary, the prompt including the metadata, the device data, and the supplementary data; and obtain, from the GenAI model responsive to the prompt, the context summary, wherein the context summary is a natural language explanation of context of the data transfer.

In some implementations, the GenAI model is a large language model (LLM).

In another aspect of the present disclosure, there is provided a method comprising: receiving an indication to view a record of a data transfer on a device; identifying metadata associated with the data transfer and device data associated with the data transfer from the device; generating a context summary of the data transfer based on the metadata and the device data using a trained machine learning model; and displaying the context summary on the device in association with the record of the data transfer.

In some implementations, the device data comprises one or more of location data, calendar data, image data, contact data, and email data of or on the device.

In some implementations, the method further comprises generating supplementary data based on the metadata and the device data by processing the metadata and the device data.

In some implementations, generating the supplementary data comprises querying third-party databases with the metadata and the device data.

In some implementations, generating the context summary comprises determining key points relating to context of the data transfer from the metadata, the device data, and the supplementary data using the trained machine learning model.

In some implementations, the trained machine learning model is a generative artificial intelligence (GenAI) model, the method further comprising: generating a prompt to the GenAI model for generating the context summary, the prompt including the metadata, the device data, and the supplementary data; and obtain, from the GenAI model responsive to the prompt, the context summary, wherein the context summary is a natural language explanation of context of the data transfer.

In another aspect of the present disclosure, there is provided a computer-readable medium comprising instructions stored therein which, when executed by a processor, cause a computer to: receive an indication to view a record of a data transfer on a device; identify metadata and device data associated with the data transfer; generate a context summary of the data transfer based on the metadata and the device data using a trained machine learning model; and display the context summary on the device in association with the record of the data transfer.

The present subject matter generally includes inferring and compiling the context or circumstances behind a data transfer. For example, this may involve identifying and collecting data from various sources that traditionally may not be directly linked with, or presented in a record for, the data transfer. The present subject matter also includes generating a summary about the circumstances, background, and/or context of the data transfer based on the collected data (referred to herein as a context summary). Trained machine learning models, including generative AI, may be used for one or more of the above steps. For example, the data transfer may be payment for a train ticket, a taxi ride, dinner at a restaurant, or a withdrawal from a bank account. However, the data transfer record (such as a credit card statement, invoice, or receipt) may only indicate that a payment for a particular amount was made to the vendor (or that a withdrawal for a particular amount from an account was made) at a particular time on a particular day. When reviewing past data transfers after a period of time, it can be difficult for the individual to remember the reason for the data transfer from the minimal information for various reasons, such as if little to no information was specified regarding the subject of the transfer, if multiple data transfers were made with the same recipient around the same time, if the recipient's legal name is different from its operating name etc. As noted above, this can lead to inaccurate or inefficient record keeping, and can make fraudulent or erroneous data transfers harder to detect. The present systems and methods can be used to help provide a reminder regarding the context or circumstances surrounding a data transfer in addition to the minimal data that is typically presented in a data transfer record.

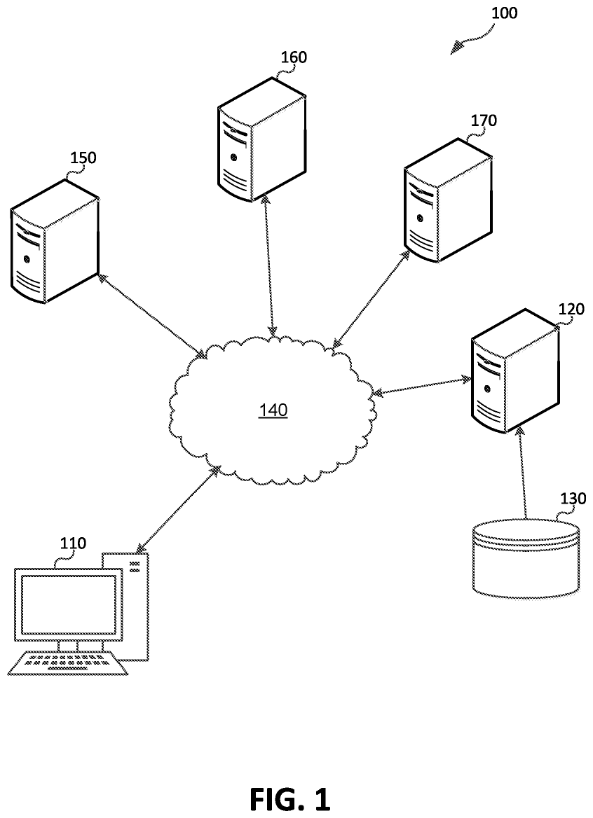

FIG. 1 is a schematic operation diagram illustrating an operating environment of an example embodiment. As shown, the system 100 includes a client device 110 and a computer system 120 with a database 130, coupled to one another through a network 140, which may include a public network such as the Internet and/or a private network. The client device 110 and the computer system 120 may be in the same location or geographically disparate locations. In other words, the client device 110 and the computer system 120 may be located remote from one another. The system 100 may further include third-party data provider computer systems. These may also be coupled to the client device 110 and the computer system 120 through the network 140.

The client device 110 may be a personal computer as shown in FIG. 1. However, the client device 110 may be a computing device of another type such as for example a smartphone, a laptop, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. The client device 110 may be associated with an entity, such as a user or client.

The computer system 120 may be, for example, a mainframe computer, a minicomputer, or the like. In some embodiments thereof, a computer system may be formed of or may include one or more computing devices. The computer system 120 may include and/or may communicate with multiple computing devices such as, for example, one or more database servers (including a database 130), computer servers, and the like. Multiple computing devices such as these may be in communication using a computer network and may communicate to act in cooperation as a computer server system. For example, the computing devices may communicate using a local-area network (LAN). In some embodiments, the computer system 120 may include multiple computing devices organized in a tiered arrangement. For example, the computer system 120 may include middle tier and back-end computing devices. In some embodiments, the computer system 120 may be a cluster formed of a plurality of interoperating computing devices.

The computer system 120 may be associated with or used by one of various institutions. In some embodiments, the computer system 120 may be associated with a financial institution and, to that end, may maintain records of customer financial accounts and associated financial data in the database 130. The database 130 may be provided internally within the computer system 120 or externally. To that end, the database 130 may be provided remotely from the computer system 120. For example, the database 130 may be stored in one or more data centers, and the data centers may store data with bank-grade security. The client device 110 may, thus, be associated with a customer having a financial account with the financial institution.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

The system 100 may further include one or more third-party systems or data provider computer systems which offer products and/or services to the user associated with the client device 110. The data provider computer systems may be in communication with the client device 110 and the computer system 120 through the network 140. The products and/or services offered, and the data provided to the client device 110, by the third-party systems may traditionally not be directly associated/linked with, or presented in a record for, a data transfer (discussed in further detail below).

The data provider computer systems may include one or more account data provider computer systems 150 and/or one or more supplementary data provider computer systems 160, 170. While the example shown in FIG. 1 shows the system 100 having one account data provider computer systems 150 and two supplementary data provider computer systems 160, 170, it will be appreciated that the system 100 may include a different number of account data provider computer systems and supplementary data provider computer systems.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components. In another embodiment, the system 100 may be a cloud-based system. For example, the computer system 120 may itself be virtual and the various components and modules thereof may be resident on a cloud. The computer system 120 may include one or more virtual machines or virtual processors that may be accessed via the cloud. In a similar manner, the account and supplementary data provider computer systems 150, 160, 170 may also be virtual and the various components and modules thereof may be resident on the cloud.

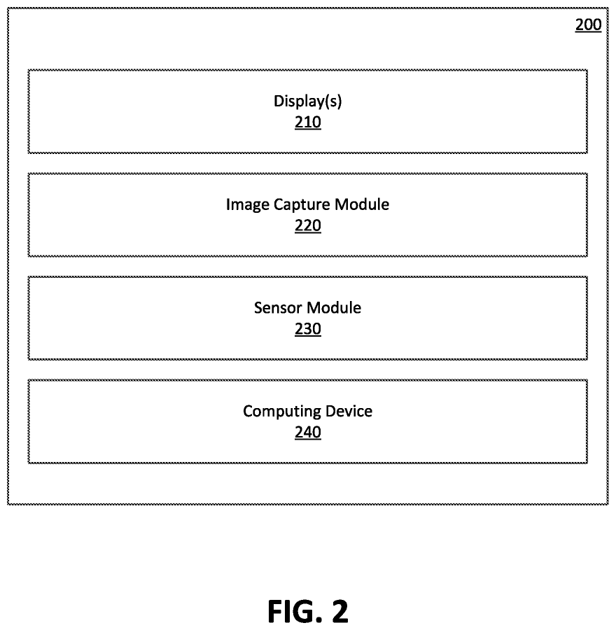

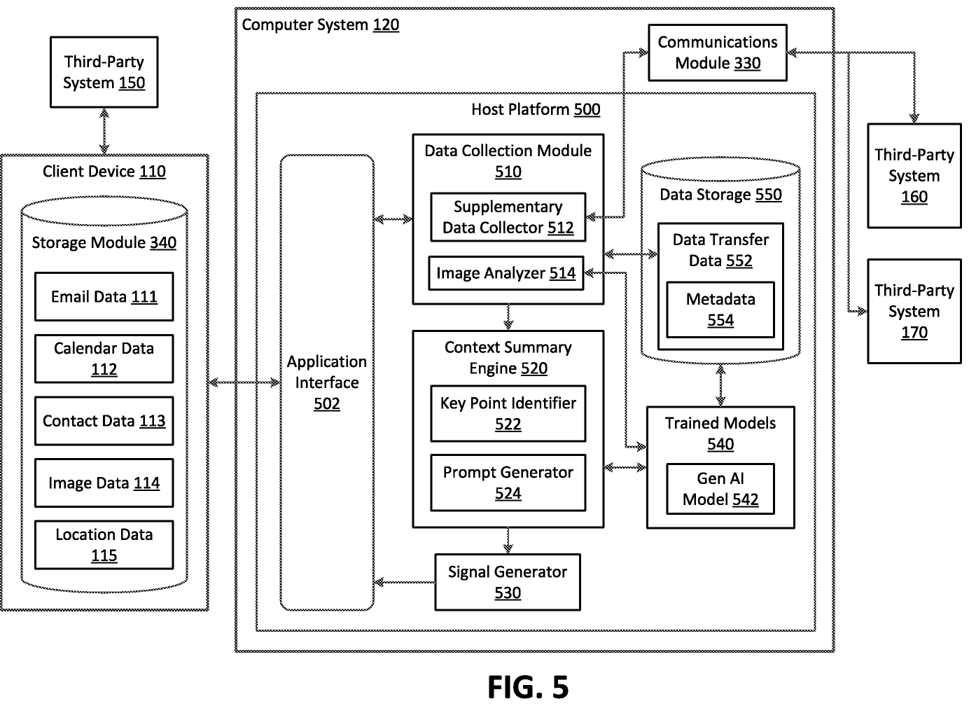

The account data provider computer system 150 may be associated with a third-party service provider, such as an email provider, a calendar service provider, and/or a contacts manager, and the user of the client device 110 may have an account with the third-party service provider to access one or more of such services. In that regard, the account data provider computer system 150 may be synchronized with the client device 110 in real-time, such that data received by the account data provider computer system 150 or generated at the client device 110 may be shared in real-time therebetween. The client device 110 and/or the account data provider computer system 150 may also store historical account data associated with the user's account. It will be appreciated that in embodiments where the system 100 includes a plurality of account data provider computer systems 150, each account data provider computer system may be associated with a different third-party and/or may provide different types of account data, such as email data, calendar data, contact data etc. This account data, when resident on the client device 110 and sent to the computer system 120, may be referred to herein as, or may form a part of, device data (further discussed with respect to FIGS. 2 and 5).

The supplementary data provider computer systems 160, 170 may be associated with third-parties configured to receive an enquiry (via the network 140 using a secured application programming interface call or request, for example) from the computer system 120 and provide supplementary data, in addition to the device data, to the computer system 120. For example, the supplementary data provider computer systems 160, 170 may be associated with other third-party service providers, such as companies who provide traffic data or weather data to the client device 110 and the computer system 120. The supplementary data may be specific to a particular (historical) date, time, and location of the client device 110.

FIG. 2 is a simplified schematic diagram showing components of the client device 110. The client device 110 may include modules including, as illustrated, for example, one or more displays 210, an image capture module 220, a sensor module 230, and a computing device 240.

The one or more displays 210 are a display module. The one or more displays 210 are used to display screens of a graphical user interface that may be used, for example, to communicate with the computer system 120 (FIG. 1). The one or more displays 210 may be internal displays of the client device 110.

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the client device 110. The location may be the current geographic location of the client device 110. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computing device 240 is in communication with the one or more displays 210, the image capture module 220, and the sensor module 230. The computing device 240 may be or may include at least one processor which is coupled to the one or more displays 210, the image capture module 220, and/or the sensor module 230.

Device data is referred to herein as data transferred from the client device 110 to the computer system 120 for the purposes of the present system and methods. Thus, the account data mentioned above, the image data from the image capture module 220, the location data from the sensor module 230, and other data generated by the client device 110 and/or received by the client device 110 from other third-party computer systems, may collectively or generally be referred to as device data.

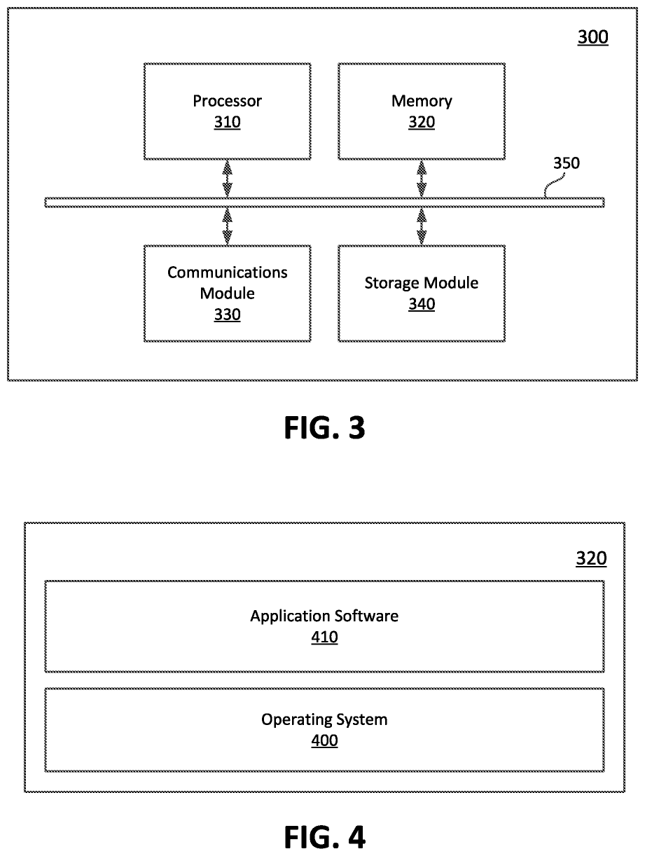

Referring now to FIG. 3, a high-level operation diagram of an example computer system 300 is shown. In some embodiments, the example computer system 300 may be exemplary of the computer system 120 and/or the client device 110 (shown in FIG. 1). The example computer system 300 includes a variety of modules. For example, the example computer system 300 may include at least one processor 310, a memory 320, a communications module 330, and/or a storage module 340. As illustrated, the foregoing example modules of the example computer system 300 are in communication over a bus 350.

The at least one processor 310 is a hardware processor. The at least one processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are non-transitory computer-readable storage mediums. A computer-readable medium may be organized using a file system such as may be administered by an operating system governing overall operation of the example computer system 300.

The communications module 330 allows the example computer system 300 to communicate with other computers or computing devices and/or various communications networks. For example, the communications module 330 may allow the example computer system 300 to send or receive communications signals to/from the client devices 110 over the network 140. Communications signals may be sent or received according to one or more protocols or according to one or more standards. For example, the communications module 330 may allow the example computing system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing system 300 to communicate using near-field communication (NFC), via Wi-Fi™, using Bluetooth™ or via some combination of one or more networks or protocols. In some embodiments, all or a portion of the communications module 330 may be integrated into a component of the example computing system 300. For example, the communications module 330 may be integrated into a communications chipset. In some embodiments, the communications module 330 may be omitted such as, for example, if sending and receiving communications is not required in a particular application.

The storage module 340 allows the example computing system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as the database 130, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the at least one processor 310 in concert with the communications module 330 such as, for example, if data is stored remotely. The storage module may also be referred to as a data store.

Software comprising instructions is executed by the at least one processor 310 from a computer-readable medium. For example, software may be loaded into random-access memory from persistent storage of the memory 320. Additionally or alternatively, instructions may be executed by the at least one processor 310 directly from read-only memory of the memory 320.

FIG. 4 depicts a simplified organization of software components stored in the memory 320 of the example computing system 300 (FIG. 3). As illustrated, these software components include an operating system 400 and an application 410.

The operating system 400 is software. The operating system 400 allows the application 410 to access the at least one processor 310, the memory 320, and the communications module 330 of the example computing system 300 (FIG. 3). The operating system 400 may be, for example, Google™ Android™, Apple™ iOS™, UNIX™, Linux™, Microsoft™ Windows™, Apple OSX™ or the like.

The application 410 adapts the example computing system 300, in combination with the operating system 400, to operate as a device performing a particular function. For example, the application 410 may cooperate with the operating system 400 to adapt a suitable embodiment of the example computing system 300 to operate as the computing system 120 and/or the client device 110 (from FIG. 1).

While a single application 410 is illustrated in FIG. 4, in operation, the memory 320 may include more than one application 410 and different applications may perform different operations. For example, in at least some embodiments in which the example computing system 300 is functioning as the client device 110, the applications 410 may include an application for displaying a graphical user interface associated with sending an application programming interface request. The computer system 120 may be configured to receive application programming interface requests and may perform operations to respond thereto.

FIG. 5 is a simplified schematic diagram showing components of the storage module 340 of the client device 110 and a host platform 500 of the computer system 120 in greater detail.

The storage module 340 of the client device 110 may store or have access to a variety of data including, but not limited to, email data 111, calendar data 112, contact data 113, image data 114, and location data 115. The email data 111, the calendar data 112, and the contact data 113, among others, may be the account data discussed above (possibly synchronized with account data provider computer systems 150), the image data 114 may be obtained from the image capture module 220, and the location data 115 may be obtained from the sensor module 230. When provided to the computer system 120 for the present purposes, the email data 111, the calendar data 112, the contact data 113, the image data 114, and/or the location data 115 may be referred to as the device data.

The computer system 120 may store computer-executable instructions in the memory 320, which may be executed by a processing unit such as the processor 310, to implement one or more embodiments disclosed herein. The depicted example embodiments are directed to the computer system 120 that hosts the host platform 500 that uses one or more trained machine learning (ML) models, which may include generative artificial intelligence (GenAI), to identify and collect data from the client device 110 and other sources traditionally not directly associated with or presented in a record for a data transfer, and generate a context summary for the data transfer. The context summary that is generated may include text-based content, an image, a combination thereof, and the like.

The memory 320 of the computer system 120 may store instructions for implementing software applications 410 hosted by the host platform 500, including an application interface 502, a data collection module 510, a context summary engine 520, a signal generator 530, trained models 540, and a data storage 550.

In the depicted example, the host platform 500 may be a cloud platform, web server, etc., that hosts software applications and other software programs that are hosted and made available on the Internet to the client device 110. The software may be accessed via a URL, mobile application, etc. In other examples, the data collection module 510, the context summary engine 520, and the signal generator 530 may reside in the memory 320 of the client device 110, while the trained models 540 and/or the data storage 550 may reside in the memory 320 of the computer system 120. Other variations are possible.

The application interface 502 may act as a software intermediary that allows an application executing on the client device 110 to communicate with an application executing on the computer system 120. The application interface 502 may allow the client device 110 to request data and may enable the computer system 120 to obtain and provide the requested data to the client device 110.

The application interface 502 may be configured to receive application programming interface requests that define parameters. The application interface 502 may perform operations to obtain data to fulfill the application programming interface requests.

In one or more embodiments, the application interface 502 may include a representational state transfer (REST) application programming interface. The REST application programming interface may utilize Hypertext Transfer Protocol (HTTP) methods (e.g. GET, POST) to receive and respond to application programming interface requests. The REST application programming interface may obtain data according to application programming interface requests and may return fixed data sets as a response to the application programming interface requests.

In one or more embodiments, the application interface 502 may include a GraphQL application programming interface. The GraphQL application programming interface may be hierarchical. The GraphQL application programming interface may obtain data according to application programming interface requests without under fetching or over fetching data.

The application interface 502 may include both the REST application programming interface and the GraphQL schemas and may perform operations to select one of the REST and GraphQL application programming interfaces. In one or more embodiments, the computer system 120 may receive an application programming interface request in a format compliant with one of the application programming interface schemas and may translate the request into another format.

The data storage 550 may store data associated with data transfers, including data transfer data 552 linked to the user associated the client device 110. The data transfer data 552 may pertain to a variety of data transfers, including conventional payment data bank account transfers etc. The data transfer data 552 includes metadata 554 which may include, among others, the date of the data transfer, the time of the data transfer, the amount of data or resource that was transferred, the legal name of the recipient to whom the transfer was made etc. The metadata 554 may optionally further include information such as the data transfer number, the type of data transfer (such as a deposit, withdrawal, purchase, or refund), the type of account being debited or credited, the credit or debit card number, the identity of the card acceptor (organization/store address), the identity of the terminal (company name from which the machine operates), the operating name of the recipient etc. While the data storage 550 may reside in the memory 320 of the computer system 120, the data storage 550 may alternatively be stored remotely from the host platform 500, and accessed as required.

When the client device 110 receives an indication from the user to view a record of a past data transfer on the client device 110, the client device 110 may convey the indication to the computer system 120 via the application interface 502. The data collection module 510 comprises instructions to the processor 310 to retrieve or collect the particular record of the past data transfer from the data transfer data 552, with its associated metadata 554. As noted above, the metadata 554 for the particular record may include, among other things, the date and time of the particular data transfer. With the date and time of the particular data transfer, the data collection module 510 further comprises instructions to the processor 310 to retrieve or collect device data associated with the particular data transfer from the storage module 340 of the client device 110.

As noted above, the device data may include one or more of the location data 115, the calendar data 112, the image data 114, the contact data 113, and the email data 111 of, or on, the client device 110 that is associated with the particular data transfer. Association with the particular data transfer may be determined in a different number of ways. For example, the location data 115, the image data 114, and/or the email data 111 on the client device 110 may have date and timestamps associated with their respective pieces of data. In such an implementation, the data collection module 510 may comprise instructions to the processor 310 to identify the location data 115, the image data 114, and/or the email data 111 that has date and timestamps that fall within a predetermined threshold relative to the date and the time of the particular data transfer. The data collection module 510 may also comprise instructions to the processor 310 to identify the calendar data 112 that falls within the predetermined threshold relative to, or that otherwise corresponds with, the date and the time of the particular data transfer.

By way of example, if the date and time of the particular data transfer was 11:32 am on Mar. 11, 2024, and the predetermined threshold was 1 hour, the data collection module 510 may comprise instructions to the processor 310 to identify and retrieve the location data 115, the image data 114, the email data 111, and/or the calendar data 112 with date and timestamps between 10:32 am and 12:32 pm on Mar. 11, 2024 from the client device 110. Alternatively, the predetermined threshold may be within the same day. In that case, the data collection module 510 may comprise instructions to the processor 310 to identify and retrieve the location data 115, the image data 114, the email data 111, and/or the calendar data 112 that is dated Mar. 11, 2024 from the client device 110. Other variations are possible. The data collection module 510 may comprise instructions to the processor 310 to apply different rules or thresholds to different data to determine association with the particular data transfer. For example, instead of, or in addition to, identifying the associated device data based on the date and timestamp, association with the particular data transfer may be determined based on the recipient of the data transfer. In that regard, the contact data 113 associated with the particular recipient may also be associated with the particular data transfer and collected.

After retrieving the device data associated with the particular data transfer, the data collection module 510 may comprise instructions to the processor 310 to identify the form of the device data. For example, if the particular device data is not in text form, (the image data 114 may include an image, for example), the data collection module 510 may further comprise instructions to the processor 310 to convert the non-text data into text data. To that end, the data collection module 510 may comprise an image analyzer 514. The image analyzer 514 may be an image processing neural network as known in the art that may be configured to automatically generate a text description of the image (image captioning) and/or to use optical character recognition (OCR) to identify text within the image.

The image analyzer 514 may be or may use a software tool or a machine learning model trained to convert the image into text in real-time. In the example embodiments, the host platform 500 may include one or more trained machine learning models 540 which are capable of receiving inputs and generating outputs in response. The trained machine learning model(s) 540 may be held by the host platform 500 within a model repository or held and accessed remotely from a cloud.

In that regard, the image processing neural network of the image analyzer 514 may be stored as one of the trained machine learning models 540. The image processing neural network may be, for example, a trained neural network, a trained deep neural network (DNN), or a trained convolutional neural network (CNN). The image processing neural network may have been trained using a training dataset of images that have been labelled with ground-truth text description. In that manner, the image processing neural network may be a first large language model (LLM), such as one that uses computer vision and natural language processing (NLP) techniques to generate the description and/or extract text from the image.

After retrieving the device data (such as the location data 115, the image data 114, the email data 111, the calendar data 112 and/or the contact data 113) associated with the particular data transfer, the data collection module 510 may also comprise instructions to the processor 310 to obtain supplementary data based on the particular data transfer data (and metadata) and the device data by processing the data transfer data and the device data. To that end, the data collection module 510 may comprise a supplementary data collector 512. The supplementary data collector 512 may be or may use a software tool to obtain data that supplements the data transfer data and the device data. The supplementary data collector 512 may obtain the supplementary data by processing the data transfer data and the device data. The processing may include querying databases of third-party systems using the data transfer data and the device data.

For example, in the illustrated embodiment, the supplementary data collector 512 is in communication with the communications module 330 of the computer system 120, which in turn may be in communication with the third-party systems, such as the supplementary data provider computer systems 160, 170 via the network 140 (see FIG. 1). As noted above, the supplementary data provider computer systems 160, 170 may be associated with third-party service providers, including companies who provide traffic data or weather data. The supplementary data may then be weather data and/or traffic data that is associated with the particular data transfer. Association with the particular data transfer may be determined in a similar manner as described above. For example, the weather data and/or the traffic data often have location, date, and time data associated with it. In such an implementation, the supplementary data collector 512 may comprise instructions to the processor 310 to identify the particular weather and/or traffic data that falls within the same (or a different) predetermined date and time threshold relative to the date and the time of the particular data transfer, and that corresponds with the location data (from the client device 110) associated with the particular data transfer.

Continuing with the above example, if the date and time of the particular data transfer was 11:32 am on Mar. 11, 2024, the predetermined threshold was 1 hour, and the location of the client device 110 during the data transfer was North York, Ontario, the supplementary data collector 512 may comprise instructions to the processor 310 to identify and retrieve the weather data and/or the traffic data with date and timestamps between 10:32 am and 12:32 pm on Mar. 11, 2024 in North York, Ontario from the supplementary data provider computer systems 160, 170. This may be done via the network 140 using a secured application programming interface call or request, for example.

After collecting the data transfer data, device data, and the supplementary data associated with the particular data transfer, the system 100 is then configured to generate the context summary for the particular data transfer based on the collected data transfer data, device data, and optionally supplementary data, using a trained machine learning model via the context summary engine 520. Among other things, the context summary engine 520 may be trained to identify the subject matter of the data transfer from the email data 111 (such as from an emailed receipt) and/or the image data 114 (such as from an image of the food ordered at a restaurant).

In one implementation, the context summary engine 520 may comprises a key point identifier 522 that has instructions to the processor 310 to determine key points relating to the particular data transfer from the collected data transfer data, device data, and (optionally) supplementary data using the trained machine learning model. The trained machine learning model may be a text summarizer trained to summarize or condense a body of text or collection of data into a specified number of key points. The text summarizer may be, for example, a trained neural network, a trained DNN, or a trained CNN. The text summarizer may have been trained using a training dataset of collections of text/data that have been labelled with ground-truth key points. In that manner, the text summarizer may be another LLM that is different from the image processing neural network discussed above. In other implementations, the same trained machine learning model may be trained and used to perform the image analysis and the key point identification described above. The key points relate to the context and circumstances of the particular data transfer and, in particular, to the most important and/or relevant aspects or facts of the circumstances of the data transfer. In that regard, the key points may themselves be considered the context summary of the particular data transfer.

For example, if the data transfer was payment for a train ticket, the key points identified may be: “Toronto to Windsor”, “Via Rail”, and “holiday”. If the data transfer was payment for an Uber ride, the key points identified may be: “Downtown Toronto” and “meeting with client X”. If the data transfer was payment for a meal at a restaurant, the key points identified may be: “East Side Mario's”, “Y's birthday”, and “veal parmesan”.

If a more comprehensive summary is desired, the context summary engine 520 may additionally or alternatively comprise instructions to the processor 310 to obtain an output summarizing the context and background of the particular data transfer into a short statement or story. To that end, the context summary engine 520 may use a trained machine learning model, such as a generative artificial intelligence (GenAI) model, to do so. In the example embodiments, the trained machine learning models 540 may be or may include a GenAI model 542, which is capable of receiving inputs (such as prompts) and generating outputs in response to the prompts. A prompt is typically understood to be a natural language input that includes instructions to the GenAI model to generate a desired output. The GenAI model 542 may be held by the host platform 500 within the model repository as one of the trained models 540, or held and accessed remotely from a cloud.

The GenAI model 542 may be a large language model (LLM) that uses natural language processing techniques to generate the output summarizing the context and background of the particular data transfer into a short statement, a story, or a natural language explanation of the context of the particular data transfer. While the machine trained models described above may be specifically trained to caption an image, identify key points from collected data, and/or to summarize the collected data into a short statement or story, those (and other) functions may also be performed by a refined or specifically trained foundational model, such as the trained GenAI model 542.

According to various embodiments, the GenAI model 542 may be an LLM, such as a multimodal large language model. As another example, the GenAI model 542 may be a transformer neural network (“transformer”) or the like. A language model may use a neural network (typically a DNN) to perform natural language processing (NLP) tasks such as language translation, image captioning, grammatical error correction and natural language generation, among others. A language model may be trained to learn parameters in order to model how words relate to each other in a textual sequence, based on probabilities. A language model may contain hundreds of thousands of learned parameters or, in the case of an LLM, may contain millions or billions of learned parameters or more. In that manner, the GenAI model 542 can learn the patterns and structure of their input training data and then generate new content that has similar characteristics.

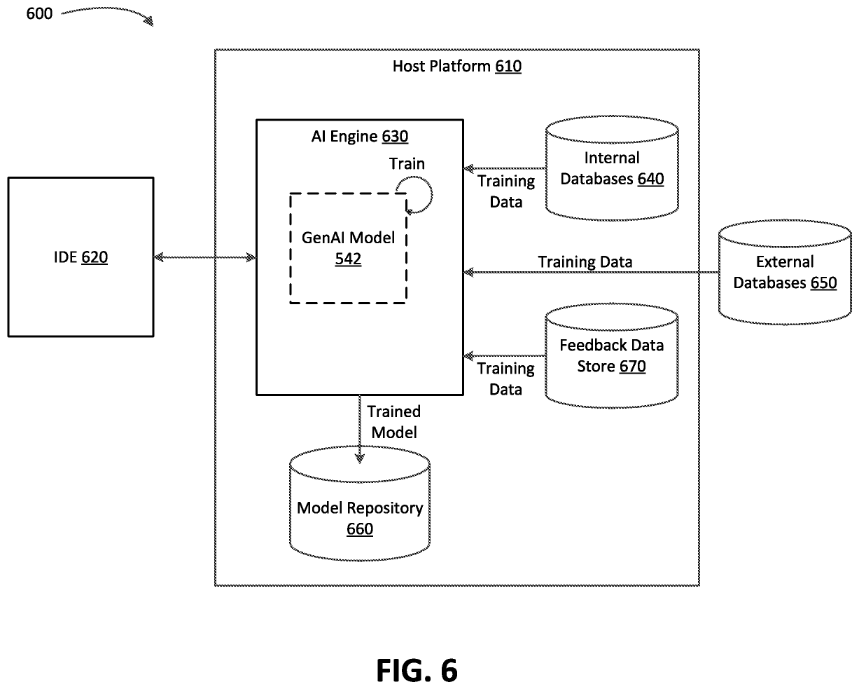

FIG. 6 schematically illustrates a process 600 of training the parameters of the GenAI model 542 according to example embodiments. However, it should be appreciated that the process 600 is also applicable to other types of models, such as other machine learning models, AI models, and the like. Referring to FIG. 6, a host platform 610 may host an IDE 620 (integrated development environment) where GenAI models, machine learning models, AI models, and the like may be developed, trained, retrained, and the like. In this example, the IDE 620 may include a software application with a user interface accessible by a user device over a network or through a local connection.

For example, the IDE 620 may be embodied as a web application that can be accessed at a network address, URL, etc., by a device. As another example, the IDE 620 may be locally or remotely installed on a computing device used by a user.

The IDE 620 may be used to design a model (via a user interface of the IDE), such as a generative artificial intelligence model that can receive data transfer data, device data, and supplementary data associated with a particular data transfer as input and generate output summarizing the context and background of the particular data transfer in a list of key points or as a short statement. The model can then be executed/trained based on training data established via the user interface. During training, the GenAI model 542 may be executed on training data via an AI engine 630 of the host platform 610.

The GenAI model 542 may be trained to understand various types and forms of data, including, inter alia, data transfer data, email data, calendar data, contact data, image data, location data, weather data, traffic data, natural language conversations, and the like based on a large corpus of documentation. The training data may be provided from a training data store such as an internal database 640, which may include training samples from the web, from customers, and the like. Additionally or alternatively, the training data may be pulled from one or more external databases 650 such as publicly available sites, etc.

In some implementations, the GenAI model 542 may also be trained with past data transfer data, device data, and supplementary data that have been labelled with ground-truth labels of their key points. The GenAI model 542 may also be trained with documents and web pages relating to data transfer data, device data, and supplementary data, related institutional sources, data from forum discussions, Q&A platforms, and other data sources that provide insight into data transfer contexts. The GenAI model 542 may also be trained with banking regulation documents pertaining to data transfers, web pages of the financial institution, and payment transfer manuals. The GenAI model 532 may also be trained with content gathered by web page scrapers or crawlers from website pages comprising data transfer best practices, recommendations, and frequently asked question (FAQ) resources, and/or to fetch them from repositories or storage.

In some embodiments, the payload of data may be in a format that is not capable of being inputted to the GenAI model 542 nor read by a computer processor. For example, the payload of data may be in text format, image format, audio format, and the like. In response, the AI engine 630 may convert the payload of data into a format that is readable by the GenAI model 542, such as a vector or other encoding. The vector may then be input to the GenAI model 542.

The AI engine 630 may iteratively retrieve additional training data sets from the internal and external databases 640, 650 and iteratively input the additional training data sets into the GenAI model 542 during the execution of the model to continue to train the model. The AI engine 630 may continue the process until it receives instructions to terminate, which may be based on a number of iterations (training loops), total time elapsed during the training process, etc.

When the GenAI model 542 is sufficiently trained, it may be stored within a model repository 660 as one of the trained models 540 via the IDE 620 or the like.

The IDE 620 may also be used to retrain the GenAI model 542 after the model has been deployed. Here, the training process may use executional results that have already been generated or output by the GenAI model 542 in a live environment (including any user feedback, etc.) to retrain the GenAI model 542. For example, outputs that are generated by the GenAI model 542 and the user feedback of the output may be used to retrain the model to further enhance the responses that are generated for all users. The feedback may include indications of whether the generated output was accurate or relevant to the particular data transfer and/or was liked and, if not, what aspects of the output were incorrect or irrelevant. This feedback data may be captured and stored within a feedback data store 670 or other data store within the live environment and can be subsequently used to retrain the GenAI model 542.

Returning to FIG. 5, the context summary engine 520 comprises instructions to the processor 310 to execute the trained GenAI model 542 to generate an output summarizing the context and background of the particular data transfer into a short statement or story.

According to various embodiments, to generate such an output, the GenAI model 542 may be executed using custom-defined prompts that may be designed to first identify key points from the data collected by the data collection module 510 (similar to that performed by the key point identifier 522), then to generate an output summarizing the context and background of the particular data transfer into a short statement or story. In some implementations, the short statement or story may be considered the context summary. In some embodiments, a separate prompt may be designed and inputted sequentially to perform each of those functions. In other embodiments, the GenAI model 542 may be executed using custom-defined prompts designed to generate output summarizing the context and background of the particular data transfer into a short statement or story straight from the inputted data collected by the data collection module 510.

In the depicted embodiment, the context summary engine 520 may comprise a prompt generator 524 for generating prompts to the GenAI model 542. Prompt engineering is the process of structing sentences (prompts) so that they are understood by the GenAI model. Part of the prompting process may include delays/waiting times that are intentionally included within the script such that the model has time to think/understand the input data. The prompt generator 524 may comprise instructions to the processor 310 to generate a prompt to the GenAI model 542 that incorporates the data transfer data, the device data, and the supplementary data to generate the context summary.

Continuing the above examples, if the data transfer was payment for a train ticket, the short statement generated by the GenAI model 542 may be: “You travelled from Toronto to Windsor on Via Rail for the holidays. The train was delayed due to snow.” This may be generated from inputting the metadata, location data, email data, calendar data, and weather data associated with the particular data transfer into the GenAI model 542. If the data transfer was payment for an Uber ride, the short statement generated may be: “Took an Uber from the office across Downtown Toronto for a meeting with client X. There was heavy traffic in the afternoon.” This may be generated from inputting the particular metadata, location data, calendar data, and traffic data into the GenAI model 542. If the data transfer was payment for a meal at a restaurant, the short statement generated by the GenAI model 542 may be: “You had dinner at East Side Mario's on Y's birthday with four other people. You had the veal parmesan and paid for everyone's meal”. This may be generated from inputting the particular metadata, location data, calendar data, and image data into the GenAI model 542.

As noted above, the context summary may take on various forms, including a listing of key points or a natural language explanation of the context of the particular data transfer. In other implementations, the GenAI model 542 may be configured to generate the context summary in the form of an image, in the form of text and an image in combination, or the like.

After generation of the context summary, the signal generator 530 comprise instructions to the processor 310 to generate and transmit a signal to the client device 110 to display the context summary with or in association with the record of the particular data transfer.

The memory 320 of the computer system 120 may store instructions for implementing software applications 410 hosted by the host platform 500, further including other modules, including a feedback module.

The feedback module may further have instructions to the processor 310 to ask for, and receive, feedback from the user about the context summary via the user interface on the client device 110. As noted above, this feedback data may be captured and stored within the feedback data store 670 or other data store within the live environment and can be subsequently used to retrain the GenAI model 542. The retrained GenAI model may be stored in the memory 320 with the other trained models 540.

In some cases, the context summary generated by the GenAI model 542 may be inconsistent or nonsensical in a number of ways, indicating that the particular data transfer may be fraudulent or erroneous. In such instances, the feedback module may further have instructions to the processor 310 to provide a mechanism for, and receive feedback from, the user indicating that the particular data transfer may be fraudulent or erroneous. If a fraudulent or erroneous indication is received, the feedback module may have instructions to the processor 310 to generate and send a notification the institution associated with the computer system 120, notifying it of the potentially fraudulent or erroneous data transfer.

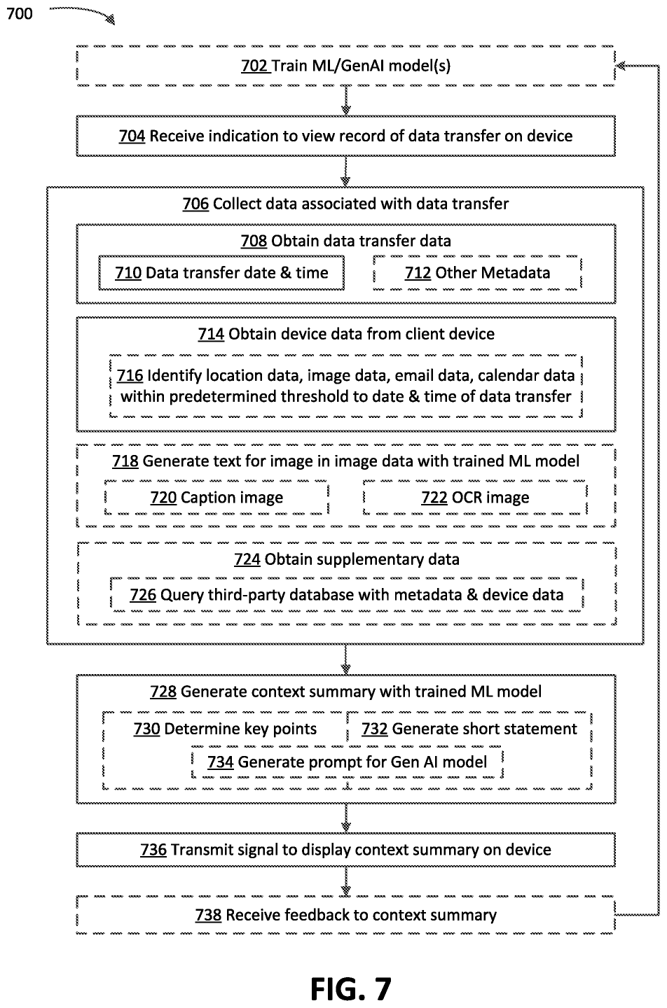

Reference will now be made to FIG. 7, which shows, in flowchart form, an example method 700 for identifying and collecting data from various sources (traditionally not directly associated with or immediately listed in a record for a data transfer), and generating a context summary for the particular data transfer. The method 700 may be implemented by way of suitably programmed processor-executable instructions stored in memory that, when executed, cause a computing device to carry out the described functions as described above. As other examples, the method 700 may be performed by another computing system, a software application, a server, a cloud platform, a combination of systems, and the like.

At operation 702, the method 700 may include training machine learning (ML) models (such as the trained models 540 described above), which may be or may include a generative AI model (such as the GenAI model 542 described above).

The GenAI model may be a new or existing foundational model refined or trained to understand data transfer data, device data, and supplementary data, natural language conversations, and the like based on a large corpus of documentation. The training data may be provided from a training data store, which may include training samples from the web, from customers, and the like. Additionally or alternatively, the training data may be pulled from one or more external databases, such as publicly available sites, etc. In some implementations, the GenAI model 542 may also be trained with documents and web pages relating to data transfer data, device data, and supplementary data, related institutional sources, data from forum discussions, Q&A platforms, and other data sources that provide insight into data transfer contexts. The GenAI model 542 may also be trained with banking regulation documents pertaining to data transfers, web pages of the financial institution, and payment transfer manuals. The GenAI model 532 may also be trained with content gathered by web page scrapers or crawlers from website pages comprising data transfer best practices, recommendations, and frequently asked question (FAQ) resources, and/or to fetch them from repositories or storage. The customized GenAI model may then be stored (in memory).

Other trained machine learning models may also be stored in memory, including an image-to-text model, an OCR model, and a text summarizer model. These models may be a trained neural network, a trained deep neural network (DNN), a trained convolutional neural network (CNN), or a recurrent neural network (RNN). These machine learning models may be trained with past data transfer data, device data, and supplementary data associated with past data transfers that have been labelled with ground-truth labels.

At operation 704, the method 700 includes receiving an indication from a user to view a record of a past data transfer with a vendor. As noted above, conventional data transfer records provided to the user tend to be high-level, non-intuitive, obscure, and/or minimal.

At operation 706, the method 700 includes retrieving or collecting data associated with the particular data transfer. At operation 708, this may involve obtaining data transfer data for the particular data transfer. The data transfer data includes metadata, comprising the date and time of the data transfer (at operation 710), and may further include other metadata for the particular data transfer (at operation 712).

The other metadata may further include, among others, the amount that was transferred, the legal name of the recipient to whom the transfer was made. The metadata may further include information such as the data transfer number, the type of data transfer (such as a deposit, withdrawal, purchase, or refund), the type of account being debited or credited, the credit or debit card number, the identity of the card acceptor (organization/store address), the identity of the terminal (company name from which the machine operates) etc.

At operation 714, retrieving or collecting data associated with the particular data transfer includes obtaining device data from the user or client device. As noted above, device data is data transferred from the client device for the purposes of the present system and methods. Thus, device data may include email data, calendar data, contacts data, image data (such as from the image capture module), location data (such as from the sensor module), and other data generated by the client device and/or received by the client device from other third-party computer systems.

Association of the device data with the particular data transfer may be determined in a different number of ways. For example, the location data, the image data, and/or the email data may have date and timestamps associated with their respective pieces of data. Thus, at operation 716, the particular location data, image data, and/or email data that has date and timestamps that fall within a predetermined threshold relative to the date and the time of the particular data transfer may be identified as device data that is associated with the particular data transfer. Operation 716 may further involve identifying the particular calendar data that falls within the predetermined threshold relative to, or otherwise corresponds with, the date and the time of the particular data transfer.

At operation 718, if the identified image data comprises an image, the method 700 may include generating text for the image using a trained machine learning model. The trained machine learning model may be an image processing neural network configured to automatically generate a text description of the image (image captioning) (at operation 720) and/or to use OCR to identify text within the image (at operation 722).

At operation 724, retrieving or collecting data associated with the particular data transfer may further include obtaining supplementary data, i.e. data that supplements the data transfer data and the device data. To that end, the supplementary data may be obtained by processing the data transfer data and the device data, such as by querying databases of third-party systems using the data transfer data and the device data (at operation 726).

The third-party systems may be associated with service providers, such as companies who provide traffic data or weather data. The supplementary data may then be weather data and/or traffic data that is associated with the particular data transfer. Association of the supplementary data with the particular data transfer may be determined in a similar manner described above.

At operation 728, the method 700 then includes generating a context summary for the particular data transfer with a trained machine learning model based on the collected data from operation 706. The context summary may be generated with different forms. At operation 730, the context summary may be generated as key points. In such an implementation, the trained machine learning model may be a text summarizer. At operation 732, the context summary may be generated as a short statement or story. In such an implementation, the trained machine learning model may be a GenAI model.

In some implementations, for operation 730, a trained machine learning model may be trained and used to determine the key points that is separate from the trained machine learning model that was used to generate text for the image in the image data (at operation 718). In other implementations, the same trained machine learning model may be trained and used to perform all of the above-noted functions, such as the Gen AI model.

If a GenAI model is used, the method 700 may further include, at operation 734, generating a prompt to the GenAI model. A prompt is typically understood to be a natural language input that includes instructions to the GenAI model to generate a desired output. Thus, at operation 734, the prompt may be generated with the data collected at operation 714 to output the key points (for operation 730) and/or to generate the short statement or story (for operation 732).

At operation 736, a signal may be generated and transmitted (such as by the signal generator described above) to the user device, where the signal incorporates the context summary from the trained machine learning models or GenAI model. The signal may be transmitted to the user device via the user interface, such as by being displayed on the graphical user interface on the display of the client with the record for the particular data transfer.

At operation 738, feedback may be received from the client device about the context summary generated by the trained machine learning model or GenAI model via the user interface. This feedback data may be captured and stored in memory or other data store and can be subsequently used to retrain the GenAI model at operation 702. The retrained GenAI model may be stored in the memory with the other trained models.

In some cases, the generated context summary may be inconsistent or nonsensical, and the feedback received from the user may be that the particular data transfer is fraudulent or erroneous. The method 700 may then further include notifying the associated institution of the potentially fraudulent or erroneous data transfer.

Providing a description surrounding the background and circumstances of a particular data transfer may help the user or individual to remember what was purchased, how the data transfer occurred, and/or why the data transfer was made. This can lead to better record keeping, and can make fraudulent or erroneous data transfers easier to detect and, subsequently, to rectify.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system, comprising:
a processor;
a communications module coupled to the processor; and
a memory coupled to the processor, the memory storing instructions that, when executed, configure the processor to:
receive an indication to view a record of a data transfer on a device;
collect metadata associated with the data transfer and device data associated with the data transfer from the device;
generate a context summary of the data transfer based on the metadata and the device data using a trained machine learning model; and
transmit a signal to the device to display the context summary in association with the record of the data transfer.

2. The system of claim 1, wherein the metadata comprises one or more of a date and a time of the data transfer.

3. The system of claim 2, wherein the device data comprises one or more of location data, calendar data, image data, contact data, and email data of or on the device.

4. The system of claim 3, wherein one or more of the location data, the image data, and the email data are identified to be associated with the data transfer when a date and timestamp associated respectively with the location data, the image data, and the email data are within a predetermined threshold relative to the date and the time of the data transfer.

5. The system of claim 3, wherein the image data comprises an image, the trained machine learning model comprises an image processing neural network trained to analyze and describe the image, and the instructions, when executed, further configure the processor to collect the image data by generating a description of the image using the image processing neural network.

6. The system of claim 4, wherein the instructions, when executed, further configure the processor to obtain supplementary data based on the metadata and the device data by processing the metadata and the device data.

7. The system of claim 6, wherein the instructions, when executed, further configure the processor to obtain the supplementary data by querying third-party databases using the metadata and the device data.

8. The system of claim 7, wherein the supplementary data comprises one or more of weather data and traffic data.

9. The system of claim 6, wherein the instructions, when executed, further configure the processor to generate the context summary by determining key points relating to context of the data transfer from the metadata, the device data, and the supplementary data using the trained machine learning model.

10. The system of claim 9, wherein the trained machine learning model is a text summarizer that uses natural language processing (NLP) techniques.

11. The system of claim 10, wherein the context summary is a listing of the key points.

12. The system of claim 6, wherein the trained machine learning model is a generative artificial intelligence (GenAI) model, and wherein the instructions, when executed, further configure the processor to:
generate a prompt to the GenAI model for generating the context summary, the prompt including the metadata, the device data, and the supplementary data; and
obtain, from the GenAI model responsive to the prompt, the context summary, wherein the context summary is a natural language explanation of context of the data transfer.

13. The system of claim 12, wherein the GenAI model is a large language model (LLM).

14. A method comprising:
receiving an indication to view a record of a data transfer on a device;
identifying metadata associated with the data transfer and device data associated with the data transfer from the device;
generating a context summary of the data transfer based on the metadata and the device data using a trained machine learning model; and
displaying the context summary on the device in association with the record of the data transfer.

15. The method of claim 14, wherein the device data comprises one or more of location data, calendar data, image data, contact data, and email data of or on the device.

16. The method of claim 15, further comprising:
generating supplementary data based on the metadata and the device data by processing the metadata and the device data.

17. The method of claim 16, wherein generating the supplementary data comprises querying third-party databases with the metadata and the device data.

18. The method of claim 16, wherein generating the context summary comprises determining key points relating to context of the data transfer from the metadata, the device data, and the supplementary data using the trained machine learning model.

19. The method of claim 16, wherein the trained machine learning model is a generative artificial intelligence (GenAI) model, the method further comprising:
generating a prompt to the GenAI model for generating the context summary, the prompt including the metadata, the device data, and the supplementary data; and
obtain, from the GenAI model responsive to the prompt, the context summary, wherein the context summary is a natural language explanation of context of the data transfer.

20. A computer-readable medium comprising instructions stored therein which, when executed by a processor, cause a computer to:
receive an indication to view a record of a data transfer on a device;
identify metadata and device data associated with the data transfer;
generate a context summary of the data transfer based on the metadata and the device data using a trained machine learning model; and
display the context summary on the device in association with the record of the data transfer.
